(19) United States
(12) Patent Application Publication
(10) Pub. No.: US 2011/0008167 A1
(43) Pub. Date: Jan. 13, 2011

(54) Hinged Sail Vertical-Axis Wind Generator for Residential Ground Operation

(75) Inventor: Christian Cummings, Lewisville, TX (US)

Correspondence Address: Christian A. Cummings, 317 Enid Drive, Lewisville, TX, 75056, US

(73) Assignee: Christian A. Cummings, Lewisville, TX (US)

(21) Appl. No.: 12/564,905

(22) Filed: Sep. 22, 2009

Related U.S. Application Data
(60) Provisional application No. 61/223,651, filed on Jul. 7, 2009.

(51) Int. Cl. F03D 3/06

(52) U.S. Cl. 416/132 A

(57) ABSTRACT

A ground-level vertical-axis wind generator introduces the use of reverse push-away hinges and soft sails specifically made for safe operation in a residential environment. The concave sails harness the wind energy, each one tensioned between two curved support arms, which connect to the central rotor via butt hinges. These hinges and soft sails yield safety to allow the wind generator to operate at ground level. The rotor drives an alternator included in the support structure of the wind generator via a gear assembly. The alternator generates the electricity and a direct current to alternating current power inverter converts the electrical current to match that of the residential utility grid. No installation is required; instead, it operates at ground-level in the backyard, which makes this safe and easy-to-assemble invention a cost effective alternative to harnessing free energy.

### BACKGROUND OF THE INVENTION

For too long have residents been at the mercy of the electric company. So many have shopped for alternative sources of electricity, only to find that free energy is very expensive. Solar panels proved to be a very expensive alternative and are years away from producing any significant electricity. The problem with wind generators in the past is that they require expensive installations on rooftops or atop towers, primarily because wind generators are dangerous, and most home-owners associations may deny such installations. These additional installation costs make traditional wind generators an expensive alternative for harnessing free energy.

There has been a continuous need and desire for cost effective generators specifically designed for residential operation that are also safe and easy to assemble. This ground-level residential wind generator has been developed for such a need and will become apparent to those skilled in the art.

### SUMMARY OF THE INVENTION

The present invention is a safe and easy-to-assemble wind generator that provides a cost effective solution to harnessing free energy.

The present invention introduces the use of reverse push-away hinges on the sail arms that connect to the central rotor to absorb any accidental impact. Further, the soft sails are made of pretreated canvas, or similar weather-resistant fabric, instead of metal or hard plastic blades. Impact with this wind generator during normal operation will not cause any permanent damage. These safety measures alone make this design a compelling alternative for residential use.

In accordance with the present invention, only light assembly is required wherein the wind generator simply plugs into a power inverter tying directly to the utility grid. It does not require installation costs.

The aim in accordance with the present invention is to supplement an ample supply of electricity thereby providing cost effectiveness while promoting a healthier environment. The goal for this invention is to generate enough electricity to reduce the residential electric bill and cover the costs of the generator itself in a short time.

Like no other, the present invention introduces reverse push-away hinges and soft sails as safety features allowing it to be used at ground level in a typical residential backyard environment. It is easy to assemble and requires no installation costs. Those skilled in the art can appreciate the above-mentioned safety features and cost-effective solutions this invention provides amongst other aspects thereof together with reading the detailed descriptions which follow in conjunction with the drawings.

### BRIEF DESCRIPTION OF THE DRAWINGS

The object and features of this invention will become more readily apparent from the following detailed description taken in conjunction with the accompanying drawings wherein:

FIG. 1 is a top plan view of the wind generator clearly indicating certain aspects to this new design;

FIG. 2 is the front view thereof;

FIG. 3 is an enlarged partial front view of the same;

FIG. 4 is an enlarged partial and transparent view of the bottom support structure that illustrates components within, which may not otherwise be seen from the perspective of the figure in accord with this invention.

### DETAILED DESCRIPTION OF THE INVENTION

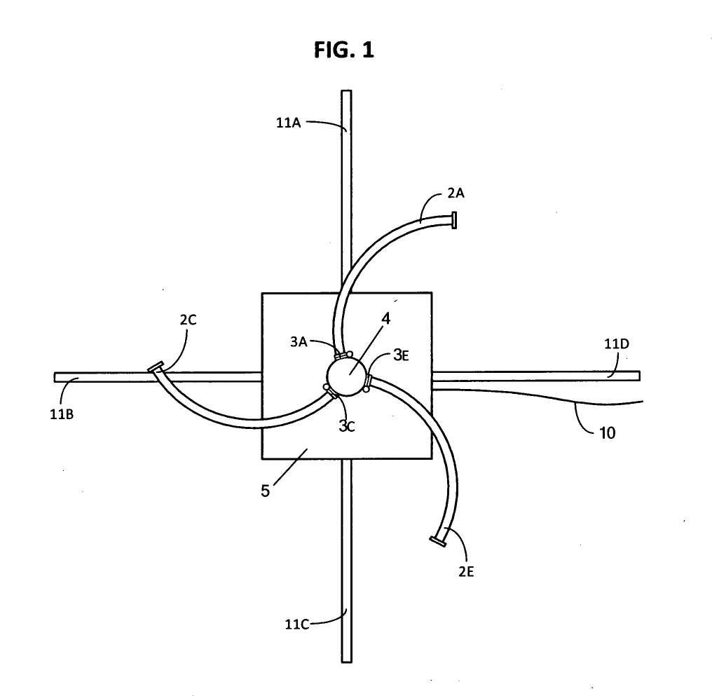

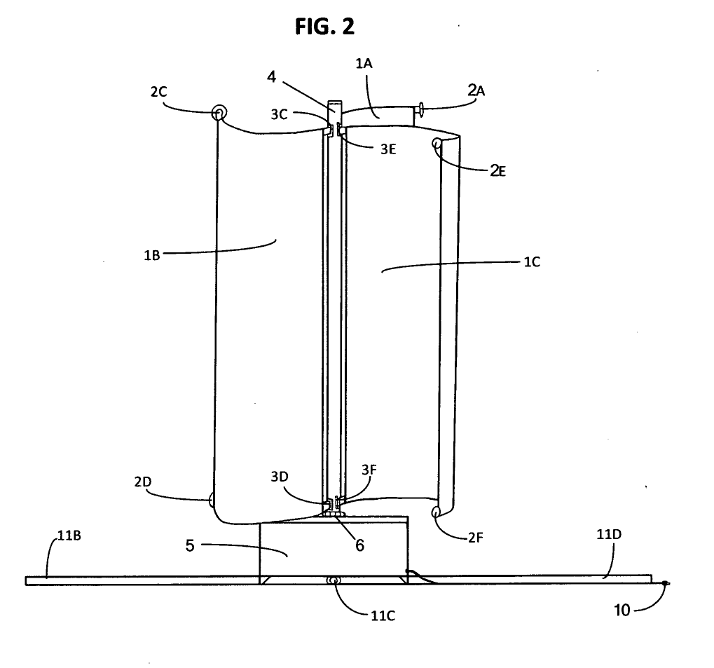

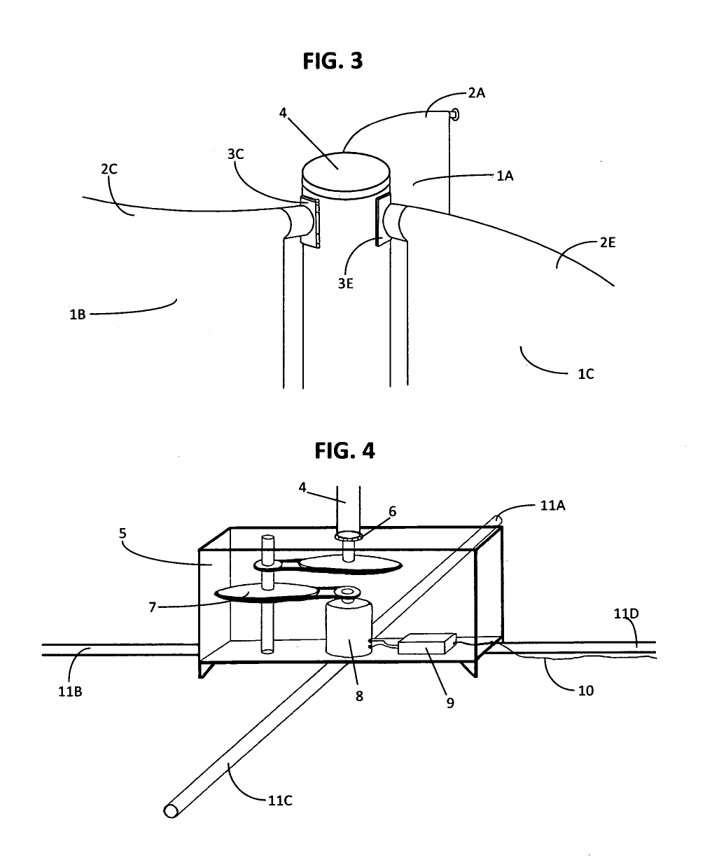

Embodiments of the present invention will be described with respect to the drawings. This innovative wind generator is designed for the backyard environment to supplement residential electrical use. It is a vertical-axis generator that uses concave sails to capture the kinetic power of the wind and convert it into household electricity. Held up by a vertical center post, or rotor 4, and sprouting curved support arms 2, the sails 1 harness the wind energy and transfer that power to spin the alternator to generate electricity. The sails 1 as illustrated in FIG. 2 are made from pretreated canvas, duck cloth, or another durable, weather-resistant fabric such as those materials used to make sails, tarps, flags, and/or tents. Each sail is held together and tensioned by curved protruding arms 2 both from the top and bottom of the vertical rotor 4. The rotor acts as the backbone of the wind generator. Its rotation in the center is produced by the sails 1 and the support arms 2. As illustrated in FIG. 1, the rotor 4 connects via hinges 3 to the support arms 2, three at the top and three at the bottom, in which each top and bottom pair is positioned equidistant from each other from the center of the rotor. As illustrated in FIG. 2, the support arms 2 sprout from the rotor horizontally perpendicular to the tangent of the rotor 4. Three sails are optimal for harnessing the wind energy, whereas the three concave sails 1 are able to capture the wind blowing from any direction. The curvature arc of the arms 2 should be concave in form so as to extend the form throughout the sails 1 therein. It is important to use lightweight, but strong materials in this design to maximize the potential for capturing the wind energy with the least resistance. The rotor 4 and support arms 2 should also be capped to prohibit water and debris from entering. Each of the arms 2 is connected to the rotor 4 by hinges 3. The hinges, like in FIG. 3, must be butt hinges. As mentioned, the arms 2 holding the sails are connected perpendicular to the rotor; therefore, the natural position of the hinges 3 has an inverse relationship to the position of the sails 1. The hinges that connect the arms to the rotor are important because they function as a safety measure in the case of accidental contact. As the wind energy puts pressure on the sails 1, in their natural open position, the hinges 3 remain at their closed position and can only transfer its energy by spinning the rotor 4. At the moment the sails come into contact in the opposite direction, wherein a sail 1 or a support arm 2 is stricken by something other than wind, such as a person or an object, the hinges 3 will allow the arms 2 to sway away from the point of contact and allow a natural cushion to help absorb some of the impact. Spring butt hinges that spring closed would place better resistance to wind blowing from the opposite direction, which would prevent the wind from fortuitously closing the sails. Also, after accidental impact, spring hinges 3, by closing, would gingerly return the sails 1 to their natural open position without the aid of the wind. The use of the hinges on the sail arms is an important safety feature that allows this wind generator to function on ground level, and therefore, be utilized by residents without the worry of permanent damage to the surrounding people, animals, or environment.

The wind generator compiles components at its base, which work together to convert the kinetic energy into electrical energy. Illustrated in FIG. 4, the base of the generator consists of a support structure 5 to house components, a turntable 6, a gear assembly 7, an alternator 8, and a power inverter 9. The power inverter illustrated in FIG. 4 suggests a pluggable grid-tie micro power inverter, although any grid-tie inverter could be used. From the pluggable micro power inverter, an electrical cable 10 is included to plug into a standard household outlet. At the very bottom of the base, there are support braces 11 to provide support at its foundation.

The wind generator is attached atop a support structure 5, which acts as a protective container for the sensitive electrical components within. The structure itself can come is various shapes. It safeguards the connections from the rotor 4 to the gear assembly 7 and from the gear assembly to the alternator 8 so that no vertical forces are pressed upon those connections by the weight of the rotor, support arms, and sails above. Additionally, the support structure 5 must be weather-resistant to shelter the electrical components within from the forces of nature.

The rotor 4 is supported by a small turntable 6, preferably one with ball bearings to reduce friction. The turntable provides support, but allows the rotor to spin freely with the wind. At the center of the turntable, there should be a hole or connection from the center of the rotor 4 above the turntable 6 through to the gear assembly 7 below the turntable. The turntable 6 is physically attached to the top of the support structure 5, and therefore, it too must also be made weather-resistant to protect the electronic equipment within. A ground wire from the turntable may be included to further protect the electrical components.

The rotor 4 spins with the sails and drives the alternator 8 rotation, which is positioned within the support structure 5. Either by a direct contact assembly or gearbox, or connected by endless belts, a gear assembly 7 is likely necessary to transition the strong, but slower, kinetic energy of the sails 1 to the rotation speed the alternator 8 requires to generate electricity. The gear assembly should be positioned under the turntable 6 inside the support structure 5 and attached within. The rotor 4 will drive the gear assembly 7, which will convert the speed of rotation from the wind energy to a much higher rotation speed to drive the alternator 8. The power of the wind energy captured by the sails 1 is adequate to overcome any resistance in the gear assembly 7 and alternator 8 to conduct the electricity.

The alternator 8 is the device that actually generates the electricity while spinning. The alternator should be positioned within the support structure 5 and attached at the bottom. The alternator 8 should be allowed to spin freely along with the gear assembly 7 and the rotor 4 above; as it spins, the alternator generates electricity and feeds the raw power to the inverter 9, or to capacitors, if desired.

Capacitors (not shown), similar to batteries, could be used in conjunction with the wind generator to provide a source of power for off-grid applications and could even be used to buffer the electrical current from the generator to the household when tied to the grid, if desired. If used, capacitors would also require the use of a charge controller so that the batteries do not overcharge. Capacitors may not be necessary for this design because the power could be regulated through the inverter 9, which, depending on the inverter used, may deliver the generated electricity directly into the power grid without the need to buffer or store the current.

The inverter 9 converts direct current (DC) from the alternator to 120 Volt alternating current (AC) at 60 Hertz to be used in conjunction with the power grid from the local utility company. A pluggable true sine wave grid-tie micro inverter is recommended for easy use and the assembly of this design. It would allow for easy assembly by simply plugging the wind generator into a standard household outlet. If used, a long electrical cable 10 would be required to connect the inverter 9 to a standard 3-prong plug made for a standard residential 120 Volt outlet.

The support structure 5 of the wind generator is positioned on support braces 11. In FIG. 4, the support braces can consist of either four long horizontal support legs 11, extending from the center, support chains, or ground stakes at the bottom, or a combination of support efforts to help stabilize the generator while subject to wind pressure. In episodes of powerful wind speeds, adequate support is crucial. If stakes or chains are used, they would need to be driven into the ground beneath. If support legs are used, they should be flat against the ground and should be buried to avoid accidental contact. It is also recommended to bury the cable 10, to provide better safety and support.

It is expected the wind generator will be subject to occasional high winds. All of the components of the wind generator must be made of robust, weather-resistant materials to endure all types of weather. Once assembled, the entire wind generator, including its base, may stand an approximate height of an average person.

The generator harnesses the power of the wind and converts it safely to electricity. It can be a practical addition to the backyard as it operates in the background, generating free electricity and reducing the draw of electricity from the utility grid. Made from lightweight, but strong materials, the generator can capture wind efficiently without the worry of causing damage to the surrounding environment. The hinges 3 that connect each of the arms 2 to the rotor 4 and the use of soft sails 1 both act as an important safety feature to prevent it from permanently damaging anyone or anything.

In accordance with the patent requirements, the present invention has been described to represent its preferred embodiment. This invention can be practiced otherwise than as specifically illustrated and described without departing from its original spirit and scope.

What is claimed is:

1) A vertical-axis wind generator specifically designed for use at ground-level residential environments by utilizing reverse push-away hinges and cloth-based sails thus allowing safe operation.

2) The vertical-axis wind generator as set forth in claim 1, comprising:
at least three concave weather-resistant cloth-based sails tensioned by upper and lower arcing support arms;
said support arms connecting to a center rotor by hinges;
said rotor shaft extending vertically upward from a support structure;
a ball-bearing turntable supporting said rotor shaft on said support structure;
a connection from the turntable to the gear assembly within said support structure;

3) The support structure as set forth in claim 2, comprising:
a gear assembly housed within said support structure;
an electrical generator/alternator housed within said support structure connecting to said gear assembly;
an optional pluggable grid-tie micro power inverter housed within said support structure wired to said electrical generator/alternator.

4) Hinges, as set forth in claim 1 and 2 connecting the claimed concave support arms to the rotor, must be used to provide reverse push-away sails from the point of impact, thus absorbing some impact in the event of accidental contact.

5) The use of weather-resistant cloth-based sails as set forth in claim 1 and 2 is to capture the wind energy, which provides an added measure of safety in the event of accidental contact.
